(19) United States
(12) Patent Application Publication
(10) Pub. No.: US 2019/0185653 A1
(43) Pub. Date: Jun. 20, 2019

(54) TYRE SEALANT LAYER

(71) Applicant: BRIDGESTONE CORPORATION, Tokyo (JP)

(72) Inventors: Pasquale AGORETTI, Roma (IT); Giuseppe PEZZULLO, Roma (IT); John Nazareno HOUSE, Roma (IT); Francesco MADAU, Roma (IT)

(73) Assignee: BRIDGESTONE CORPORATION, Tokyo (JP)

(21) Appl. No.: 16/311,524

(22) PCT Filed: Jun. 20, 2017
(86) PCT No.: PCT/EP2017/065004

§ 371 Date: Dec. 19, 2018

(30) Foreign Application Priority Data
Jun. 22, 2016 (IT) 10201600064778

(51) Int. Cl. C08L 23/22; C08L 23/28; C08K 3/22

(52) U.S. Cl. CPC C08L 23/22; C08L 23/28; C08K 3/22; C08K 2003/2272; C08K 2201/01; C08K 2201/005; C08K 2201/011

(57) ABSTRACT

Tyre sealant layer made from a rubber compound comprising at least a polymer base and a filler comprising a magnetic material in the form of nanoparticles with dimensions of between 1 and 100 nm.

The present invention relates to a compound for the preparation of a tyre sealant layer.

In order to counteract the effects deriving from the puncturing of tyres, the utilization of a sealant layer arranged within the inner cavity of the tyre has been known of for a long time. Such a sealant layer can either be in contact with the inflation gas within the tyre or else covered with a protective polymer or elastomeric layer. In particular, the sealant layer is generally arranged onto the central area of the inner cavity at the tread strip.

In particular, the aim of the sealant layer is to surround and adhere to the object that penetrated the tread, thus preventing deflation of the tyre thanks to instantaneous “sealing”. Furthermore, if the penetrated object escapes, the material of the sealant layer will fill the hole left by the object thereby sealing the same.

Part of tyre research is focused on improving the effectiveness of the sealant layer with special attention to the rheological characteristics thereof. In fact, the viscosity of the sealant layer must guarantee both the sealing action with respect to the penetrated object and with respect to any hole as described above, and the stability thereof within the inner cavity independently of the static or dynamic conditions of the tyre.

The inventors of the present invention have made a tyre sealant layer whose technical characteristics are such to guarantee an improvement in sealing performance.

The object of the present invention is a tyre sealant layer made from a rubber compound comprising at least a polymer base and a filler; said sealant layer being characterized in that said filler comprises a magnetic material in the form of nanoparticles with dimensions of between 1 and 100 nm.

Preferably, said polymer base comprises an essentially saturated polymer.

Here and hereinafter “essentially saturated polymer” refers to a polymer made with less than 15 mole % of diene monomers.

Preferably, the rubber compound comprises from 5 to 50 phr, more preferably from 15 to 30 phr, of said magnetic material.

Preferably, said magnetic material is a magnetic ferrite.

Preferably, said magnetic ferrite is comprised within the group composed of barium ferrite, strontium ferrite, cobalt ferrite, manganese ferrite, maghemite (γ-Fe₂O₃) or mixtures thereof.

Preferably, said polymer base comprising an essentially saturated polymer is a halobutyl and/or butyl rubber.

Another object is a tyre comprising a sealant layer according to the present invention.

The following are examples of non-limiting embodiments given purely by way of illustration.

Five compounds were prepared (A-E), wherein the first three (A-C) represent three comparison examples, while the fourth and fifth (D and E) are examples of compounds made according to the dictates of the present invention.

In particular, the comparison compound A relates to a compound currently utilized for the preparation of sealant layers, comparison compound B differs from comparison compound A in the addition of a magnetic ferrite the particles thereof having dimensions greater than 100 nm, while comparison compound C differs from comparison compound A in that the carbon black has been replaced by a magnetic ferrite the particles thereof having dimensions greater than 100 nm.

The compound of the invention D differs from comparison compound A in that a magnetic ferrite has been added, the particles thereof having dimensions of between 1 and 100 nm, whereas the compound of the invention is distinct from comparison compound A insofar as the carbon black has been replaced by a magnetic ferrite, the particles thereof having dimensions of between 1 and 100 nm.

In essence, the comparison compounds B and C differ from the respective (“respective” refers to the presence or absence of carbon black) compounds of the invention D and E as regards the dimensions of the magnetic ferrite particles.

In Table I the compositions in phr of the five compounds are listed.

TABLE I

| | A | B | C | D | E |
|---|---|---|---|---|---|
| Br-IIR | 100 | | | | |
| Liquid P-Butene | 350 | | | | |
| Carbon black | 20 | 20 | — | 20 | — |
| Magnetic Ferrite* | — | 20 | 20 | — | — |
| Magnetic Ferrite** | — | — | | 20 | 20 |

BR-IIR stands for bromobutyl rubber.
The magnetic ferrite* with the formula Fe₂O₃ (Magnetite) is marketed by the company INOXIA and has a dimension of 53 μm and a density of 5200 Kg/m².
The magnetic ferrite** with the formula Fe₂O₃ (Magnetite) is marketed by the company IO-LI-TEC and has a dimension between 20 and 30 nm and a density of 5175 Kg/m².

The following is the procedure for the mixing step.

### Mixing Step

The ingredients listed in Table I were mixed together and left to stir at 100° C. for a period of 10 min.

From each of the compounds made as described above, a related sealant layer was produced.

Tests in order to verify the sealing properties of the above layers were performed on the tyres upon which, under the same conditions, a respective sealant layer deriving from the compounds A-E was applied. Specifically, the sealant layer was extruded directly onto the surface of the inner cavity of the tyre.

The tests involved pressure retention following the puncturing of the tyre made with a standard nail (the same type of nail) and the degree of coverage of the nail by the sealant once it had been removed.

In particular, the pressure retention test was performed both with a stationary tyre and under conditions of a tyre in rotation (20 Hz).

The tyres, after being inflated to the same internal pressure, were subjected to the same puncturing conditions with the subsequent removal of the nail. For each of the tyres subjected to the test, the pressure retention was measured 24 h after puncturing (and subsequent removal of the object).

As mentioned above, one of the tests regarding the sealing capacities of the layers involved assessing the degree of coverage by the sealant layer of the nail that performed the puncturing.

In Table II the values relating to both the air retention and the degree of nail coverage are listed. For a more immediate evaluation of the advantages conferred by the present invention, the values of Table II are expressed in indexed form with respect to the results obtained for compound A.

The higher the values reported, the better the sealing capacity of the associated layer.

From the results of Table II, it is clear that the presence of magnetic material in the form of nanometric particles within the sealant layer (layer associated with compounds D and E of the invention) guarantees greater sealing performance than that found for the commonly utilized sealant layer (layer associated with compound A of the invention).

Furthermore, a comparison of the values for the compounds B and C and the values relating to the respective compounds D and E shows how the dimensions of the particles of the magnetic material play a fundamental role in the advantages that the same magnetic material confers to the sealant layer. Indeed, it has been experimentally proven by the inventors that, if the particles of the magnetic material have dimensions that are greater than 100 nm, the viscoelastic properties of the sealant layer are such that they cancel out the advantages of using the magnetic material itself.

Finally, it has been found that the presence of the magnetic material within the sealant layer causes the same to also interact with other metal tyre parts, thus ensuring the retention of the layer during the puncture filling step.

1. Tyre sealant layer made from a rubber compound comprising at least a polymer base and a filler; said sealant layer being characterized in that said filler comprises a magnetic material in the form of nanoparticles with dimensions of between 1 and 100 nm.

2. Sealant layer according to claim 1, characterized in that said polymer base comprises an essentially saturated polymer.

3. Sealant layer according to claim 1, characterized in that said rubber compound comprises from 5 to 50 phr of said magnetic material.

4. Sealant layer according to claim 1, characterized in that said rubber compound comprises from 15 to 30 phr of said magnetic material.

5. Sealant layer according to claim 1, characterized in that said magnetic material is a magnetic ferrite.

6. Sealant layer according to claim 5, characterized in that said magnetic ferrite is comprised within the group composed of barium ferrite, strontium ferrite. cobalt ferrite, manganese ferrite, maghemite (γ Fe2O3) or mixtures thereof.

7. Sealant layer according to claim 1, characterized in that said polymer base comprising an essentially saturated polymer is a halobutyl and/or butyl rubber.

8. Tyre comprising a sealant layer according to claim 1.
